(19) United States
(12) Patent Application Publication
(10) Pub. No.: US 2008/0170382 A1
(43) Pub. Date: Jul. 17, 2008

(54) Lighted helmet

(76) Inventors: Charles Mass, Medicine Hat (CA); Richard Chailler, Claimount (CA); Brad Boksteyn, Grand Prairie (CA)

Correspondence Address: Jim Helfrich, 200 Choteau St, Sun River, MT, 59483, US

(21) Appl. No.: 11/653,113

(22) Filed: Jan. 16, 2007

(51) Int. Cl. F21V 21/084; F21V 23/00

(52) U.S. Cl. 362/105; 362/295

(57) ABSTRACT

An illuminated safety helmet device typically associated and used during sporting events, such as cycling, in-line skating, skateboarding, skiing, snow boarding and occupations such as fire fighting, construction workers, oil field employees. The illuminated helmet device of the present invention includes LED's to provide bright alternating sources of intense light for better location of the helmet. The LED's may be adjusted to increase brightness or blink time to provide better visibility in current conditions.

### RELATED APPLICATIONS

The present application is related to U.S. Pat. No. 6,244,721 B1, issued Jun. 12, 2001, for ILLUMINATED HELMET DEVICE, by Rodriguez, included by reference herein. The present application is related to U.S. Pat. No. 5,931,559, issued Aug. 3, 1999, by Pfaeffle, included by reference herein. The present application is related to U.S. Pat. No. 5,588,736, issued Dec. 31, 1996, for SELF-LLGHTED SAFTEY HELMET, by Shea, Sr., included by reference herein.

### FIELD OF THE INVENTION

The present invention relates to a safety helmet and, more particularly, to a lighted safety helmet for increased visibility and safety for the wearer.

### BACKGROUND OF THE INVENTION

Individuals working or recreating in hazardous conditions face multiple problems one of which is head trauma. Safety helmets have been developed and used for a long time to help prevent or eliminate head trauma and they are effective in doing so to a very high degree. Unfortunately reduction of head trauma has been the priority rather than prevention of the event in the first place. Many times total prevention is not possible or feasible but when it can be it should be which has not been addressed by prior inventions. Visibility and the ability to locate or know where a persons head is can often eliminate the problem all together but no prior solution exists.

Several other solutions do exist in an attempt to create better visibility of the safety helmet wearer and they include a prior invention by Rodriguez U.S. Pat. No. 6,244,721, Shea Sr. In U.S. Pat. No. 5,588,736 and Pfaeffle in U.S. Pat. No. 5,931,559 all addressing the problem though fiber optics and luminescence of the shell.

All prior solutions attempt to improve the visibility of the helmet through a consistent steady source of light ignoring the fact that often surrounding lights or obstacles may interfere with the noticeability of the object. Tests have proven that an intense blinking light will be far more noticeable than a steady low intensity light. So while these lighted helmets do improve viability in low light conditions they are often completely ineffective in adverse conditions such as when the helmet is traveling though a variation of other light sources such as on a bicycle, or in a fire where lights are effected by fire light and in fog, smoke or dust conditions where low intensity of lights may be blocked by ambient light conditions.

It is therefore an object of the invention to increase the visibility thus the safety of the user by being visible in all lighting conditions.

It is another object of the invention to provide an opportunity to prevent accidental impact by knowing where the wearer is located.

It is another object of the invention to provide a low cost alternative to other more expensive methods of location.

It is another object of the invention to be available to sports and commercial users to increase the awareness of those who would otherwise be unnoticed placing them in peril.

It is yet another object of this invention to provide the user with the ability to vary the light intensity of the helmet to meet existing conditions.

### SUMMARY OF THE INVENTION

In accordance with the present invention, there is provided an illuminated safety helmet device typically associated and used during sporting events, such as cycling, in-line skating, skateboarding, skiing, snow boarding and occupations such as fire fighting, construction workers, oil field employees. The illuminated helmet device of the present invention includes LED's to provide bright alternating sources of intense light for better location of the helmet. The LED's may be adjusted to increase brightness or blink time to provide better visibility in current conditions.

The helmet device includes a foam layer and an outer hard shell. The foam layer is contoured and shaped like the user's head while the outer shell is secured to the foam layer. The foam layer and outer hard shell are designed and configured according to the safety standards as set forth by known safety organizations, such as the American National Standards Institute.

At least one light emitting diode light source is secured to the exterior of the helmet. Activation of the light source will inherently increase the visibility of the user for alerting others of their presence in a variety of light and visibility conditions.

Other components can be used with the illuminated helmet of the present invention. These added components enhance the final product. Some of the features include, but are not limited to, the use of a reflective material secured to the shell, a strap for securing the device to the user, and air vents for permitting adequate air circulation.

### BRIEF DESCRIPTION OF THE DRAWINGS

A complete understanding of the present invention may be obtained by reference to the accompanying drawings, when considered in conjunction with the subsequent, detailed description, in which:

FIG. 1 is a top front perspective view of an illuminated safety helmet;

FIG. 2 is a rear perspective view of an on/off switch and intensity switch;

FIG. 3 is a right side perspective view of a neck and lower head protection material; and

FIG. 4 is a top perspective view of an illuminated safety helmet.

For purposes of clarity and brevity, like elements and components will bear the same designations and numbering throughout the Figures.

### DESCRIPTION OF THE PREFERRED EMBODIMENT

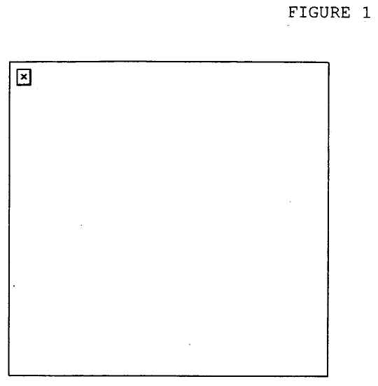

FIG. 1 is a top 34 front 30 perspective view of an illuminated safety helmet 10.

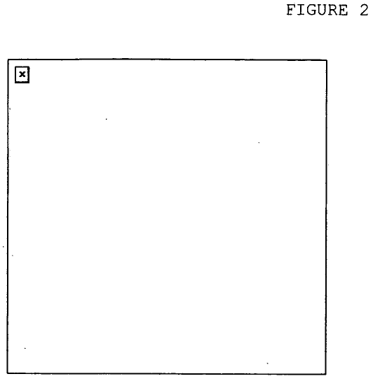

FIG. 2 is a rear 32 perspective view of an on/off switch and intensity switch 16.

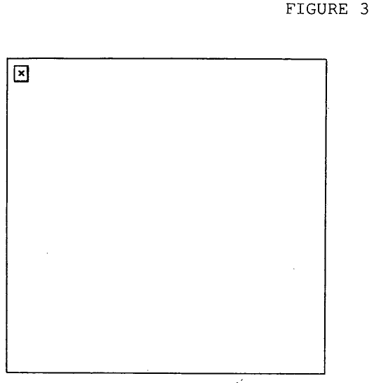

FIG. 3 is a right side perspective view of a neck and lower head protection material.

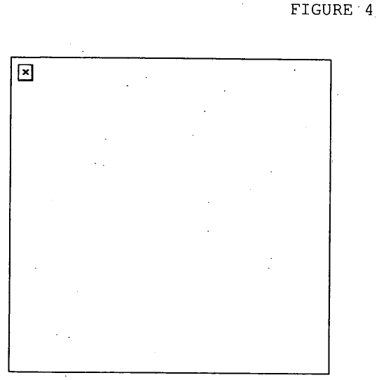

FIG. 4 is a top 34 perspective view of an illuminated safety helmet 10.

Referring now to FIGS. 1-5 thereof, there is shown a preferred embodiment of the illuminated helmet 10 device of the present invention.

As seen, the helmet 10 device of the present invention includes an inner protective foam 20 layer and an outer hard shell. This inner protective foam 20 layer is designed and configured to absorb energy from a potential impact, while the outer shell 28 with its ridge contours 26 will deflect sharp and obtrusive foreign objects.

The inner protective foam 20 layer will contact the head of the user and provides for the interior of the helmet 10. The outer hard shell constitutes the exterior of the helmet 10. As seen in the drawings, particularly FIG. 1, the helmet 10, further includes a front 30, rear 32, and top 34 surface. The front 30 can further include a visor 24 (illustrated in FIG. 2, 4) for providing a means of offering protection from the sun to the user. This visor 24 can be either permanently secured to the front 30 of the helmet 10, or optionally, can be removably secured to the helmet 10 via conventional attaching means, The helmet 10, as seen in FIGS. 1-4, has a substantially contoured shape dimensioned to fit at least partially over the head of the individual using the device. As seen in FIGS. 1-4, extending through the foam layer and hard shell are a plurality of apertures or air vents 18. These apertures or air vents 18 allow air to circular there through and will allow heat to escape from the interior of the unit. A chin strap 22 (illustrated in FIG. 2), can be used to secure the helmet 10 to the user. As illustrated, the strap is attached to the exterior or hard shell of the helmet 10.

A light emitting diode 12 means (LED) is secured to the exterior of the helmet 10. This light emitting diode 12 is secured to the exterior of the helmet 10 at various locations around the helmet 10 o provide the best visibility from all angles as shown in FIGS. 1-4.

The illumination means, as seen in FIGS. 1-4 comprises a light emitting diode 12 powered via a power source 36 and coupled to an activation means 14.

To accommodate the power source 36, a cavity, illustrated in FIGS. 3, is located within the protective foam 20 layer. This power source cavity 38 will frictionally receive, engage and maintain the power source 36, thereby providing the power source 36 to snap into place within the groove. Located within the top 34 surface of the protective foam 20 layer is a channel 40. These channels will receive wiring 42 for allowing the power supply to be coupled to the activation means 14 and the activation means 14 to be coupled to the light emitting diode 12. When the hard shell is secured to the foam layer, the channel 40 is not visible.

For activating and energizing the light source, an activation means 14 is utilize. The activation means 14 comprises a pressure switch located within the interior of the protective foam 20 layer and, as seen, extends downwardly and into the interior of the helmet 10. Activation occurs upon user activation through pressuring the switch. For determining the intensity an intensity switch 16 is also located in the wiring 42 array. The user may adjust the intensity switch 16 to increase or decrease the intensity of the light emitting diodes or to facilitate a steady or alternating light being emitted from the light emitting diodes.

In the preferred embodiment described above, in particular the embodiments illustrated in FIGS. 1-4, each can include additional elements for enhancing the final product. As shown in FIGS. 1-4, the helmet 10 can be any size, shape or color. For example lights located on the front 30 can be white while lights located at the side could be blue rear 32 can be red.

In addition, any number of light sources and any combination of light sources can be used with the present invention.

The helmet 10 of the present invention is designed and configured with safety in mind. This system will automatically operate a light source for further enhancing the present invention.

While the invention has been particularly shown and described with reference to a preferred embodiment thereof, it will be understood by those skilled in the art that various changes in form and detail may be made without departing from the spirit and scope of the invention.

Since other modifications and changes varied to fit particular operating requirements and environments will be apparent to those skilled in the art, the invention is not considered limited to the example chosen for purposes of disclosure, and covers all changes and modifications which do not constitute departures from the true spirit and scope of this invention.

Having thus described the invention, what is desired to be protected by Letters Patent is presented in the subsequently appended claims.

What is claimed is:

1. A lighted helmet for improving the safety and visibility of the user, comprising: means for protecting the head of the wearer from impact and shock that would cause trauma to the human head;
means for lighting up the helmet at various intensities to increase visibility under varying light conditions;
means for increasing or decreasing the power to the LED to make it more or less bright or to cause it to blink or be steady in its light emission;
means for intercepting shock and impact by crushing to absorb the impact that otherwise would strike the wearers head; and
means for powering the LED lights.

2. The lighted helmet in accordance with claim 1, wherein said means for protecting the head of the wearer from impact and shock that would cause trauma to the human head comprises an exterior wall, interior wall, vented, shock absorbing, impact absorbing, cushioned helmet.

3. The lighted helmet in accordance with claim 1, wherein said means for lighting up the helmet at various intensities to increase visibility under varying light conditions comprises a bright, luminescent light emitting diode.

4. The lighted helmet in accordance with claim 1, wherein said means for increasing or decreasing the power to the LED to make it more or less bright or to cause it to blink or be steady in its light emission comprises a voltage variable intensity switch.

5. The lighted helmet in accordance with claim 1, wherein said means for intercepting shock and impact by crushing to absorb the impact that otherwise would strike the wearers head comprises a shock absorbing, impact absorbing ridge contours.

6. The lighted helmet in accordance with claim 1, wherein said means for powering the LED lights comprises an electrical energy power source.

7. A lighted helmet for improving the safety and visibility of the user, comprising: an exterior wall, interior wall, vented, shock absorbing, impact absorbing, cushioned helmet, for protecting the head of the wearer from impact and shock that would cause trauma to the human head;
a bright, luminescent light emitting diode, for lighting up the helmet at various intensities to increase visibility under varying light conditions;
a voltage variable intensity switch, for increasing or decreasing the power to the LED to make it more or less bright or to cause it to blink or be steady in its light emission;
a shock absorbing, impact absorbing ridge contours, for intercepting shock and impact by crushing to absorb the impact that otherwise would strike the wearers head; and
a provides electrical energy power source, for powering the LED lights.

8. A lighted helmet for improving the safety and visibility of the user, comprising: an exterior wall, interior wall, vented, shock absorbing, impact absorbing, cushioned helmet, for protecting the head of the wearer from impact and shock that would cause trauma to the human head;
a bright, luminescent light emitting diode, for lighting up the helmet at various intensities to increase visibility under varying light conditions;
a voltage variable intensity switch, for increasing or decreasing the power to the LED to make it more or less bright or to cause it to blink or be steady in its light emission;
a shock absorbing, impact absorbing ridge contours, for intercepting shock and impact by crushing to absorb the impact that otherwise would strike the wearers head; and
a provides electrical energy power source, for powering the LED lights.
